(19) United States
(12) Patent Application Publication
(10) Pub. No.: US 2009/0196076 A1
(43) Pub. Date: Aug. 6, 2009

(54) INTEGRATED BASE DRIVER AND SWITCHING WINDINGS FOR AN ESBT POWER DRIVER

(75) Inventors: Eric Danstrom, Palatine, IL (US); John S. Lo Giudice, Palatine, IL (US)

Correspondence Address: STMICROELECTRONICS, INC., MAIL STATION 2346, 1310 ELECTRONICS DRIVE, CARROLLTON, TX, 75006, US

(73) Assignee: STMicroelectronics, Inc., Carrollton, TX (US)

(21) Appl. No.: 12/023,236

(22) Filed: Jan. 31, 2008

(51) Int. Cl. H02M 3/335

(52) U.S. Cl. 363/21.15

(57) ABSTRACT

A power supply circuit includes: a switching flyback transformer having a primary winding and a secondary winding; a current transformer having a primary winding and a secondary winding; and a switching transistor have a conduction path and a control terminal. The primary winding of the switching flyback transformer, the primary winding of the current transformer and the conduction path of the switching transistor are coupled together in a series circuit. The switching flyback transformer and the current transformer share a common core. The windings of the switching flyback transformer may be wound around one leg of the common core, while the windings of the current transformer may be wound around a different leg of the common core.

### FIELD OF THE INVENTION

The present invention relates to power supplies and, in particular, to a power supply including a flyback converter.

### BACKGROUND OF THE INVENTION

Reference is made to FIG. 1 which illustrates a simplified schematic diagram of a flyback converter. The converter comprises a switching (flyback) transformer having a primary and a secondary winding. The primary winding Np is connected in a series circuit with an input voltage Vᵢₙ and a switching power transistor T for controlling the passing of a primary current I_{T}. There is a voltage drop V_{T} across the switching transistor T. A clipping circuit is connected across the primary winding. The secondary winding Ns generates an output (secondary) current I_{D} which passes through a diode and forms an output voltage Vout and output current Iₒᵤₜ across a filtering capacitor C and a resistive load R_{L}. Control is exercised over the switching on/off of the switching transistor T in a manner known to those skilled in the art using a voltage control V_{T}. Two modes of operation are recognized for this circuit: discontinuous mode and continuous mode.

FIG. 2 illustrates waveforms relating to a discontinuous mode flyback operation of the flyback converter of FIG. 1. FIG. 3 illustrates waveforms relating to a continuous mode flyback waveforms operation of the flyback converter of FIG. 1.

The discontinuous mode, shown in FIG. 2, has no front-end step in its primary current, I_{T}, and at turn-off, the secondary current I_{D}, is a decaying triangle which drops to zero before the next turn-on. In the continuous mode, shown in FIG. 3, the primary current I_{T} has a front-end step and the characteristic appearance of a rising ramp on a step. During the transistor off time (FIG. 3), the secondary current I_{D} has the shape of a decaying triangle sitting on a step with the current still remaining in the secondary at the instant of the next turn-on. There is, therefore, still some energy left in the secondary at the instant of next turn-on.

The two modes show significantly different operating properties and usages. The discontinuous mode responds more rapidly and with a lower transient output voltage spike in response to sudden changes in load current and input voltage.

On the other hand, discontinuous mode provides a secondary peak current in the range of two or three times the continuous mode. This can be easily understood by comparing FIG. 2 and FIG. 3.

The secondary current average value is equal to the DC load current, as reported in both the above mentioned figures. Assuming also closely equal off time, it is obvious that the triangle in the discontinuous mode must show a much larger peak than the trapezoid of the continuous mode to get the same average value. Therefore, in the discontinuous mode, the larger secondary peak current, at the beginning of turn-off, will cause a greater RFI problem.

Secondary rms current in the discontinuous mode can be up to twice that in the continuous mode. This requires larger secondary wire size and output filter capacitors with larger ripple current ratings for the discontinuous mode. Rectifier diodes will also have a higher temperature rise in the discontinuous mode because of the larger secondary rms current.

Primary peak currents for the discontinuous mode are about twice those in the continuous mode. As a result, the discontinuous mode requires a higher current rating and possibly a more expensive power transistor. Also, the higher primary current in the discontinuous mode results in a greater RFI problem.

Despite all these relative disadvantages, the discontinuous mode is much more frequently used for low power applications. This is due to two reasons.

Firstly, as mentioned above, the discontinuous mode, with an inherently lower transformer magnetizing inductance, responds more quickly and with a lower transient output voltage spike to rapid changes in output load current or input voltage. Secondly, because the transfer function of the continuous mode has a right half plane zero, the error amplifier bandwidth must be drastically reduced to stabilize the feedback loop. As a consequence, the transient response is much slower.

Finally, it is known that the discontinuous mode sometimes cannot be used because it would determine a very high primary and secondary peak current with a higher cost of all the main components involved: power transistor, secondary diode and output capacitor.

The minimization of the power drawn from the mains under light load conditions (Stand-by, Suspend or some other idle modes) is an issue that has recently become of great interest, mainly because new and more severe standards are coming into force.

The key point of this strategy is a low switching frequency. It is well-known that many of the power loss sources in a lightly loaded flyback waste energy proportionally to the switching frequency, hence this should be reduced as much as possible. On the other hand, it is equally well-known that a low switching frequency leads to bigger and heavier magnetics and makes filtering more troublesome. It is then advisable to make the system operate at high frequency under nominal load condition and to reduce the frequency when the system works in a low-consumption mode.

This requires a special functionality of the controller. It should be able to automatically recognize the condition of light or heavy load and then adjust its operating frequency accordingly. It is known in the art to utilize a pulse-width modulation (PWM) controller in this application. For example, the L5991 PWM controller from STMicroelectronics, with its “Stand-by function,” satisfies this requirement.

Reference is now made to FIG. 4 which illustrates a schematic of a power supply circuit utilizing a pulse-width modulation (PWM) controller (and in particular the L5991 PWM controller from STMicroelectronics). The power supply circuit is of the flyback design like that shown in FIG. 1 and which uses a PWM driver for the switching power transistor. The circuit includes a switching (flyback) transformer T1 and a base driver (current) transformer T2 which is associated with the switching power transistor.

Connector J1 receives a DC input voltage of, for example, between 250V DC to 850V DC in this application. This input voltage may be generated from an AC source using an appropriate AC-to-DC converter such as a diode bridge. The circuitry connected immediately to connector J1, comprising resistors R1-R10, fuse F1 and capacitors C1-C2 forms an input filtering network and bias supply circuit. R1 can comprise a thermistor. This circuitry also functions as current sensor, as will be discussed below.

A PWM control loop circuit is comprised of resistors R12-R19, capacitors C3-C8, diode D1, transistor Q2, integrated circuit U1 which is the PWM controller (and in particular the L5991 PWM controller from STMicroelectronics); and a receiver half of integrated circuit U2 which is an opto-coupler circuit (for example, STMicroelectronics PC817). This circuitry receives power from the bias supply circuit through resistor R10 (along with some auxiliary supply as discussed below), and filtered by capacitor C7. Input to the PWM controller is a feedback signal received from the output of the opto-coupler circuit U2 (as feedback for voltage regulation, as will be discussed in more detail below, from the output of the overall circuit). The output of the PWM controller is at node OUT (pin 10 of the L5991 PWM controller).

The transistor Q2, resistors R13 and R16, diode D14 and capacitor C5 form a slope compensation circuit (for subharmonics suppression) utilizing an emitter follower stage configuration connected to the PWM controller integrated circuit U1. This compensation circuit compensates for changes in the DC input voltage at connector J1. Such changes can cause oscillations in the ultimate output voltage (on the secondary side of the switching transformer T1) corresponding to instances of input voltage change. The compensation circuit output (voltage shifted by diode D1) is applied to the current sensing input of PWM controller integrated circuit. This is not the only current sensing information which is received by the PWM controller (as will be described below).

Attention is directed to “Minimize Power Losses of Lightly Loaded Flyback Converters With The L5991 PWM Controller,” STMicroelectronics Application Note AN1049 (March 2000) and “Primary Controller With Standby,” STMicroelectronics Data Sheet for L5991 and L5991A (August 2001), both documents incorporated by reference herein, for details on the connection and use of the L5991 PWM controller in this and other comparable circuit applications.

The generated bias voltage output from the input filtering network and bias supply circuit is provided from resistor R10 to a base drive circuit network comprised of resistors R11 and R22-26; diodes D2-D3, capacitor C10, transformer T2 and transistor Q1. Transistor Q1 is an emitter switched bipolar transistor (ESBT) such as the hybrid emitter switched bipolar transistor STC08DE150 from STMicroelectronics which functions as the switching power transistor for the converter. See, “Hybrid Emitter Switched Bipolar Transistor ESBT 1500V-8A-0.075Ω”, STMicroelectronics Data Sheet for STC08DE150 (November 2004), the document incorporated by reference herein, for details on the connection and use of the ESBT in circuit applications. The gate terminal (input) for the MOSFET portion of hybrid transistor Q1 receives the output of the PWM controller at node OUT of the PWM control loop circuit (see, pin 10 of the L5991 PWM controller). This signal controls the conduction of current through the primary winding of the current transformer T2 as well as the current through a first primary winding of the switching transformer T1. The secondary of the current transformer T2 provides feedback into the base drive circuit network including switching transistor Q1. In practical applications where the load is variable, the collector current through transistor Q1 is variable. As a consequence, it is very important to provide a base current to Q1 which is related to the collector current. In this way, it is possible to avoid device over saturation at low load and to optimize the performance in terms of power dissipation. This is accomplished in the base drive circuit network through a proportional driving method provided by the current transformer T2. The core magnetic permeability of the current transformer T2 must be as high as possible in order to minimize magnetization current which is not transferred from primary to secondary, but rather drives the core into saturation. An inductance (not shown) can be placed in series with the primary winding of transformer T2 and diode D3 to function as a spike and ringing filter during shut down.

The base drive circuit network further outputs, through resistor R24, a current sensing signal (indicative of current flowing through the switching transistor Q1) which is applied to the current sensing input of PWM controller integrated circuit (as described above).

The resistor chain including resistor R8 of the input filtering network and bias supply circuit is a current sensor which senses unacceptable high ramp up of current on the primary side of transformer T1. Such may be caused, for example, by a short circuit at the output (see, connectors J2 and J3 discussed below). This signal output from resistor R8 is filtered by capacitor C8 and resistor R24 and applied to the current sensing input of PWM controller integrated circuit.

It is useful to provide a short pulse to the base of transistor Q1 to make the turn-on as fast as possible and to reduce the dynamic saturation phenomenon. This pulse is achieved by using the capacitor C10 and zener diode D2 in the base drive circuit network.

An auxiliary supply circuit is also provided comprised of diodes D4 and D8, capacitor C11, and a second primary winding on switching transformer T1. The circuit may further include an optional inductance connected between the diode D8 and a first terminal of the second primary winding (for filtering purposes). A second terminal of the first primary winding is connected to ground. The output of this auxiliary supply is provided from diode D4 to supplement the bias supply output from the bias supply circuit at resistor R10.

The first primary winding of transformer T1 is connected at the first terminal to the connector J1, while a second terminal of the first primary winding is connected to both diode D7 and to the primary winding on current transformer T2. Thus, the signal output from the PWM controller at node OUT of the PWM control loop circuit (see, pin 10 of the L5991 PWM controller) controls the conduction of current through both the primary winding of the transformer T2 and the first primary winding of transformer T1.

The first primary winding of transformer T1 is further connected to a snubber circuit comprised of resistors R20-21, Capacitor C9, and diodes D5-D7. The snubber works in both discontinuous and continuous mode. The output diode turns off at zero current (in discontinuous mode after the core of transformer T1 is discharged). In continuous mode, the output diode turns off when transistor Q1 turns on. A ringing occurs on reverse recovery. The snubber is based on a tuned capacitance and resistance circuit.

Turning next to the secondary side of the switching transformer T1, a first secondary winding and a second secondary winding are provided. The first secondary winding is associated with circuitry for outputting a first output voltage (in this example, 24V), while the second secondary winding is associated with circuitry for outputting a second (different) output voltage (in this example, 5V). In the illustrated embodiment, the first output voltage is a voltage which is regulated through an opto-isolated feedback signal applied back on the primary side of transformer T1 to the PWM control loop circuit. Conversely, the second output voltage is voltage which is regulated using voltage regulation circuitry (as will be discussed) without any feedback to the primary side of transformer T1.

With respect to the first output voltage, a first output voltage generation circuit comprises resistor R27, diodes D9, capacitors C13-C15, and output connector J2. An optional resistance may be connected across the terminals of connector J2. An optional inductance may be connected between capacitors C14 and C15. The diodes D9 may comprise an STTH3002CT circuit from STMicroelectronics. The first output voltage generation circuit functions as a filter to provide a DC output at connector J2 from the AC input provided from the first secondary winding of transformer T1. This voltage output is feedback regulated as discussed herein.

With respect to the second output voltage, a second output voltage generation circuit comprises diode D10, capacitors C16-C17, voltage regulator integrated circuit U3 and connector J3. The voltage regulator integrated circuit U3 may comprise an L78L05 voltage regulator from STMicroelectronics. Any suitable output voltage may be provided at J2 by proper selection of the voltage regulator integrated circuit U3. Configuration and connection of the voltage regulator integrated circuit U3 is well known to those skilled in the art.

Voltage regulation with respect to the first output voltage is provided through an opto-isolated feedback signal applied on the primary side of transformer T1 to the PWM control loop circuit. An opto-coupling circuit is provided on the secondary side of transformer T1. This circuit comprises resistors R28-R31, capacitor C18, integrated circuit U4, and the emitter half of integrated circuit U2 which is the opto-coupler circuit (for example, STMicroelectronics PC817). The opto-coupling circuit with the opto-isolated feedback signal provides for continuous current mode loop stabilization of the first output voltage. The circuitry provides for high DC gain necessary for good line and load regulation. The circuitry further provides requisite pole/zero compensation in the feedback loop for stability.

### SUMMARY

In an embodiment, a power supply circuit comprises: a switching flyback transformer having a primary winding and a secondary winding; a current transformer having a primary winding and a secondary winding; and a switching transistor having a conduction path and a control terminal. The primary winding of the switching flyback transformer, the primary winding of the current transformer and the conduction path of the switching transistor are coupled together in a series circuit. The switching flyback transformer and the current transformer share a common core.

The windings of the switching flyback transformer may be wound around one leg of the common core, while the windings of the current transformer may be wound around a different leg of the common core.

In an embodiment, a power supply circuit comprises: a transformer core having a first leg and a second leg; a switching flyback transformer having a primary winding and a secondary winding which are wound around the first leg of the core; a current transformer having a primary winding and a secondary winding which are wound around a second leg of the core; and a switching transistor having a conduction path and a control terminal. The primary winding of the switching flyback transformer, the primary winding of the current transformer and the conduction path of the switching transistor are coupled together in a series circuit.

In another embodiment, a method for power supply generation comprises: defining a first magnetic path associated with switching flyback transformer operation through a magnetic core including at least a first leg and a second leg, wherein the first magnetic path passes through both the first and second legs; defining a second magnetic path associated with current transformer operation through the same magnetic core, wherein the second magnetic path passes through the second leg but not the first leg; and passing current used to generate both the first and second magnetic path through a series circuit.

### BRIEF DESCRIPTION OF THE DRAWINGS

Preferred embodiments according to the present invention will now be described with reference to the Figures, in which like reference numerals denote like elements and wherein:

FIG. 1 illustrates a simplified schematic diagram of a flyback converter;

FIG. 2 illustrates discontinuous mode flyback waveforms for the flyback converter of FIG. 1;

FIG. 3 illustrates continuous mode flyback waveforms for the flyback converter of FIG. 1;

FIG. 4 illustrates a schematic of a power supply circuit utilizing a pulse-width modulation (PWM) controller;

FIG. 5 illustrates a schematic of an improved power supply circuit utilizing a pulse-width modulation (PWM) controller and integrated transformers;

FIG. 6 which shows a perspective view of a switching transformer of a type suitable for use as a switching flyback transformer in FIG. 4 and an integrated transformer in FIG. 5;

FIG. 7 shows two facing E shaped cores as may be used in a switching transformer of the type shown in FIG. 6; and

FIG. 8 which shows the assembly of two facing E shaped cores to form an EE type core as may be used in the integrated transformer used in the circuit of FIG. 5.

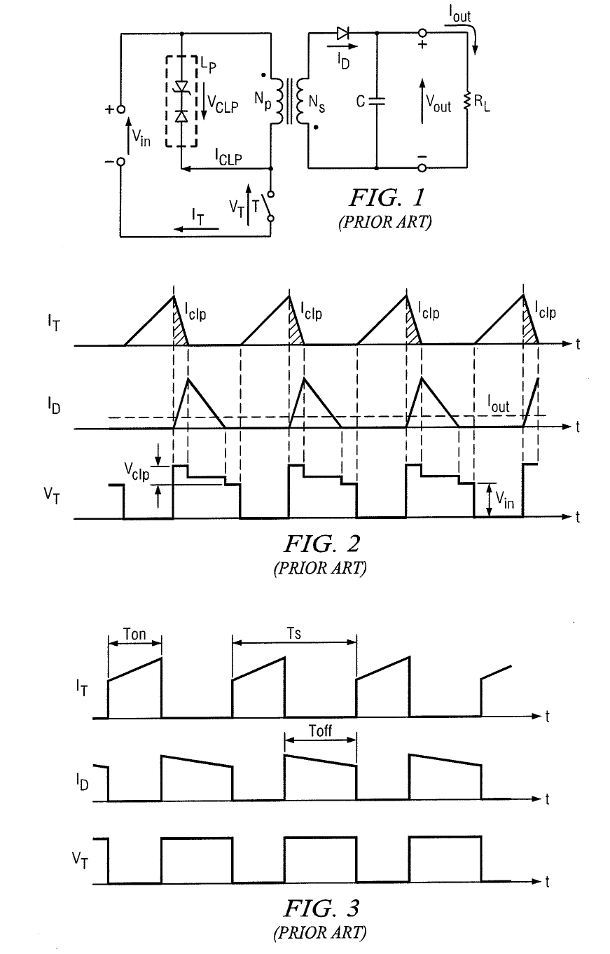

### DETAILED DESCRIPTION OF THE DRAWINGS

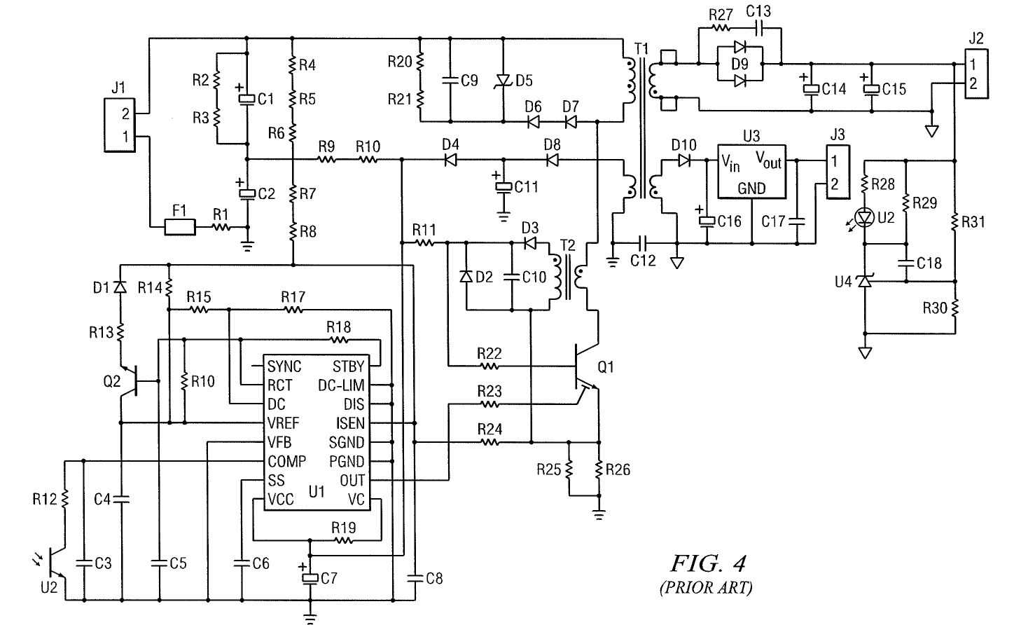

In the configuration shown in FIG. 4, transformer T2 is the current transformer in the base drive circuit, while transformer T1 is the switching or flyback transformer. As shown, the magnetics of these two transformers are separate (i.e., they have separate and distinct cores).

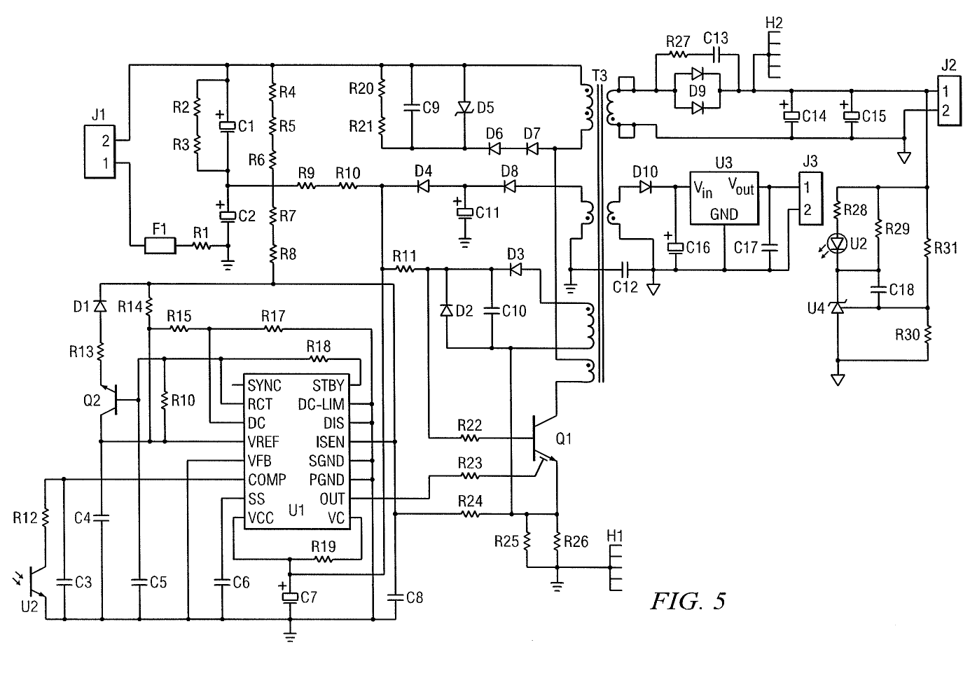

Reference is now made to FIG. 5 which illustrates a schematic of an improved power supply circuit utilizing a pulse-width modulation (PWM) controller with an integrated transformer. The discussion herein will be limited to the changes and improvement presented over the circuit of FIG. 4. Like reference numbers have been used in FIGS. 4 and 5 to refer to identical components and connections.

The circuit of FIG. 5 uses a transformer T3 which integrates (i.e., combines) the transformers T1 and T2 which are shown separately in FIG. 4. Thus, the current transformer in the base drive circuit and the switching or flyback transformer are integrated together. In the preferred embodiment, these transformers are wound on a common core in a manner discussed herein.

With reference to FIG. 4, it will be noted that the current which flows through the first primary winding of transformer T1 also flows through the primary winding of transformer T2. Thus, the information passing through the emitter switched bipolar transistor (ESBT) Q1 is the same for both transformer T1 and transformer T2. There is accordingly no harm from a signal perspective to provide the first primary winding of transformer T1 and the primary winding of transformer T2 on a common core (i.e., a core with at least partially shared magnetic paths). Additionally, the secondary winding of transformer T2 can be placed on that same core. This is illustrated in FIGS. 5, 6 and 8.

The circuit in FIG. 5 is otherwise electrically connected the same that shown in FIG. 4.

Mechanically speaking, the integration of transformers T1 and T2 into transformer T3 with a common core can be accomplished in a number of ways. One way is to use a custom wound transformer which would include all the necessary windings (in this case, with four windings on the primary side and two windings on the secondary side) on a common core. Another option is to use a commercial transformer having an accessible core with two windings each on the primary and secondary sides (such as might be used for transformer T1 in FIG. 4), and then wind the primary and secondary windings of what was transformer T2 around the accessible core of the commercial transformer so as to make integrated transformer T3. Yet another option is to use a commercial transformer (with two windings each on the primary and secondary sides such as might be used for transformer T1 in FIG. 4) which also has outside legs of the core which are accessible, and then wind the primary and secondary windings of what was transformer T2 around the accessible outside legs of the commercial transformer so as to make transformer T3. In this option, the transformer can be selected such that the outside legs of the core have a high permeability similar to the type of core which would have been used for transformer T2 in the FIG. 4 implementation (for example, a toroid).

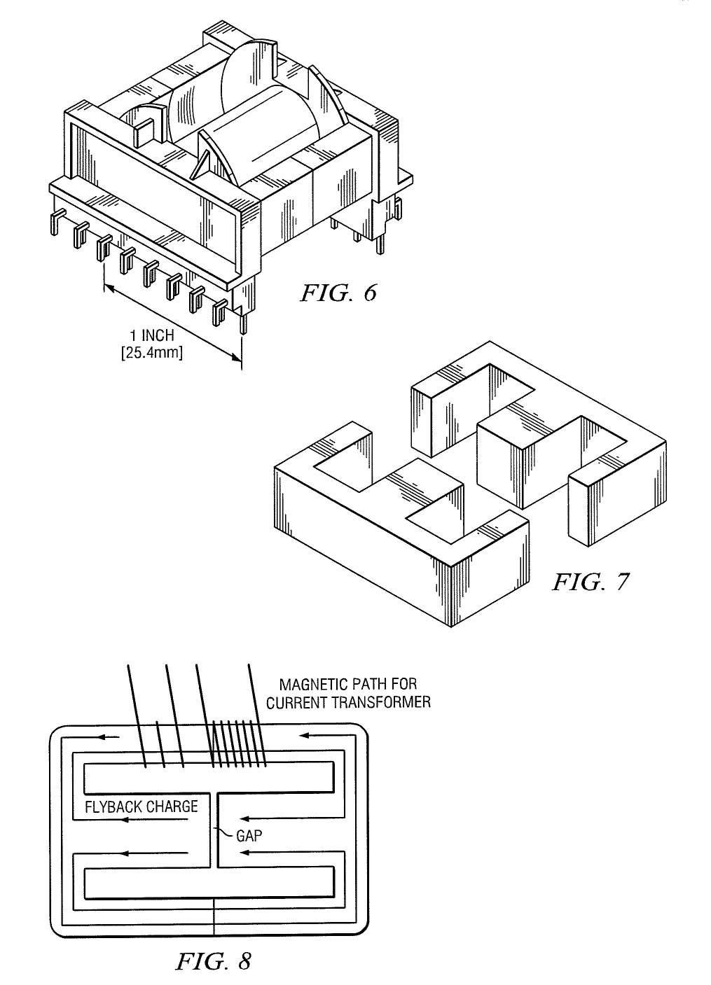

Reference is now made to FIG. 6 which shows a perspective view of switching transformer of a type suitable for use as transformer T1 in FIG. 4 and which can be modified for implementing integrated transformer T3 of FIG. 5. This switching transformer may, for example, comprise any suitable switching transformer, for example having an EE or an EI type core (where E and I refer to core shapes). The core of the transformer may be of PC 40 material or equivalent. The transformer includes a plastic bobbin with pins. The windings of the switching transformer (i.e., the flyback windings) are wound around the bobbin.

FIG. 7 shows two back to back E shaped cores as may be used in a switching transformer of the type shown in FIG. 6. At least the E shaped core in the EI type core (and both facing E shaped cores in the EE type core) include a central leg which passes through a central opening in the bobbin.

Reference is now made to FIG. 8 which shows the assembly of two E shaped cores forming an EE type core as may be used in the switching transformer of the type shown in FIG. 6. FIG. 8 does not show, for reasons of simplifying the illustration and ensuring that features discussed herein are not obscured, the bobbin and the windings of the switching transformer. It will be noted that a gap is provided between the two center legs of the facing E shaped cores which would pass through the center opening in the bobbin (not shown). Likewise, a gap would be provided between the center leg of an E shaped core and the body of a facing I shaped core in an EI type core. This gap is present to reduce the inductance of the material and store energy for the switching or flyback operation. The outside legs of the facing E shaped cores, however, do make contact with each other. Contact would likewise be made between the outside legs of E and I shaped cores in an EI type core.

FIG. 8 further illustrates the magnetic path for flyback switching transformer charge within the EE type core due to the windings on the bobbin (not shown). This magnetic path passes through the central leg(s) and around the bodies and outside legs of the facing E shaped cores. For flyback, during the charge cycle the magnetic path flows as indicated and stores energy in the gap. During discharge, the magnetic path reverses and the flow discharges the energy stored in the gap.

It will be noted that the bodies and outside legs of the facing E shaped cores form a loop. This structure is similar in effect to a toroid, and it recognized by those skilled in the art that toroid shaped cores are well suited for use in current transformers such as transformer T2 in FIG. 4. The integrated transformer T3 used in FIG. 5 takes advantage of this by having the windings of the current transformer be wound around at least one of the outside legs (see, also FIG. 6). FIG. 8 illustrates the magnetic path for the current transformer charge around the bodies and outside legs of the facing E shaped cores. This magnetic path which does not pass through the gap keeps the inductance high as is required for a current transformer.

Although an E shaped core is shown, it will be understood that cores of other shape can be used as long as the two necessary magnetic paths for the two transformers are supported.

One clear advantage of this implementation is to save space on the circuit board through the elimination of the footprint of transformer T2. Another advantage is a reduction in cost (for both materials and assembly) due to the integration of transformer T2.

While this detailed description has set forth some embodiments of the present invention, the appended claims are sufficiently supported to cover and will cover other embodiments of the present invention which differ from the described embodiments according to various modifications and improvements apparent to those skilled in the art.

What is claimed is:

1. A power supply circuit, comprising:
a switching flyback transformer having a primary winding and a secondary winding;
a current transformer having a primary winding and a secondary winding; and
a switching transistor having a conduction path and a control terminal;
wherein the primary winding of the switching flyback transformer, the primary winding of the current transformer and the conduction path of the switching transistor are coupled together in a series circuit; and
wherein the switching flyback transformer and the current transformer share a common core.

2. The power supply circuit of claim 1 wherein the switching flyback transformer comprises at least an E shaped core having a center leg and two outside legs, with a bobbin around the center leg, and wherein the primary and secondary windings of the switching flyback transformer are wound around the bobbin, and wherein the primary and secondary windings of the current transformer are wound around at least one of the outside legs.

3. The power supply circuit of claim 2 wherein the switching flyback transformer comprises a facing E shaped core having a central leg and two outside legs, and wherein there is a gap between the central legs and no gap between the outside legs.

4. The power supply circuit of claim 1 wherein the switching flyback transformer comprises a core having a first leg and a second leg, with a bobbin around the first leg, and wherein the primary and secondary windings of the switching flyback transformer are wound around the bobbin, and wherein the primary and secondary windings of the current transformer are wound around the second legs.

5. The power supply circuit of claim 1 wherein a magnetic path through the core relating to the switching flyback transformer and a magnetic path through the core relating to the current transformer at least both pass through a common section of the core.

6. The power supply circuit of claim 5 wherein the magnetic path through the core relating to the switching flyback transformer passes through a gap provided in the core while the magnetic path through the core relating to the current transformer does not pass through the gap.

7. A power supply circuit, comprising:
a transformer core having a first leg and a second leg;
a switching flyback transformer having a primary winding and a secondary winding which are wound around the first leg of the core;
a current transformer having a primary winding and a secondary winding which are wound around a second leg of the core; and
a switching transistor having a conduction path and a control terminal;
wherein the primary winding of the switching flyback transformer, the primary winding of the current transformer and the conduction path of the switching transistor are coupled together in a series circuit.

8. The power supply circuit of claim 7 wherein a magnetic path through the core relating to the switching flyback transformer and a magnetic path through the core relating to the current transformer at least both pass through the second leg.

9. The power supply circuit of claim 8 wherein the magnetic path through the core relating to the current transformer does not pass through the first leg.

10. The power supply circuit of claim 9 wherein first leg of the core includes a gap for storing energy associated with operation of the switching flyback transformer.

11. The power supply circuit of claim 7 wherein the core includes at least one E shaped element having a center leg and two outside legs.

12. The power supply circuit of claim 11 wherein a magnetic path through the core relating to the switching flyback transformer and a magnetic path through the core relating to the current transformer at least both pass through one of the outside legs.

13. The power supply circuit of claim 12 wherein the magnetic path through the core relating to the current transformer does not pass through the center leg.

14. A method for power supply generation, comprising:
defining a first magnetic path associated with switching flyback transformer operation through a magnetic core including at least a first leg and a second leg, wherein the first magnetic path passes through both the first and second legs;
defining a second magnetic path associated with current transformer operation through the same magnetic core, wherein the second magnetic path passes through the second leg but not the first leg; and
passing current used to generate both the first and second magnetic path through a series circuit.

15. The method of claim 14, further comprising switching the current in the series circuit.

16. The method of claim 15 wherein switching comprises controlling current flow in the series circuit with a pulse width modulated signal.

17. The method of claim 16 further comprising altering the pulse width modulated signal is response to a feedback signal generated from a secondary side of the switching flyback transformer.
